(19) United States
(12) Patent Application Publication
(10) Pub. No.: US 2016/0199974 A1
(43) Pub. Date: Jul. 14, 2016

(54) Crank Handle with Hole

(71) Applicant: Harry WONG, South Pasadena, CA (US)

(72) Inventor: Harry WONG, South Pasadena, CA (US)

(21) Appl. No.: 14/595,652

(22) Filed: Jan. 13, 2015

(51) Int. Cl. B25G 3/36; B25F 5/02; G05G 1/08

(52) U.S. Cl. CPC B25G 3/36; G05G 1/085; B25F 5/02

(57) ABSTRACT

Present invention provides a handy device to increase working leverage when other tools are used; a Z-shaped portion containing the bent flat area provides a “cradling” support to human hands and prevents slippage when power is exerted to the tool. A hole, and potential additional holes, can be made to the flat area, serving to provide “hooking” storage and other applicable purposes.

### FIELD AND BACKGROUND OF THE INVENTION

The present invention relates to a device for attaching to other hand tools, for the purpose of increasing torque and user leverage, enhancing work performance.

Sometimes the hand tools are used as a “make-shift” hammer, when a worker can just use the hand tool to smash or hammer down a nail, without the need to switch over to a real hammer. With the crank handle attached, it increases the convenience of the worker's use and prevents accidental slipping away where there are swinging motions.

The hole(s) made in the middle portion of the crank handle also adds to the convenience of temporarily storing the tool away. In the case of a pair of pliers, as shown in FIG. 2, there would be no need to close the jaw portion of the pliers to hang it on a hook (on a wall, for example), when the hole on the crank handle adds to the convenience for easily hooking up to something as temporary storage.

### SUMMARY OF THE INVENTION

Present invention provides a one-piece construction crank handle made up of three portions: threaded portion, Z-shaped portion, and an end portion. The axial lines of threaded portion and the end portion generally can be made to be parallel to each other in a 3-D relationship.

The Z-shaped portion sits in the middle and has a generally flat area forming a bent angle. A hole is made to the generally central area of the flat area. Additional holes can be made to the flat area.

A connection tip of smaller diameter is made to the distal end of the threaded portion, allowing easy guidance into attachment with other tools.

When such attachment to other tools is done, the torque is increased when a user uses/operates the combined tool. The bent shape flat portion provides a stoppage location to prevent slipping away of a user's hand, helping to reduce accidents.

### DESCRIPTION OF THE DRAWINGS

The accompanying drawings, which are incorporated in and constitute a part of this specification, illustrate the preferred embodiments of the invention and together with the description, serve to explain the principles of the invention.

A brief description of the drawings is as follows:

FIG. 1 shows the overall design of the one-piece crank handle.

FIG. 2 shows how the crank handle is attached to another hand tool to increase working leverage.

FIG. 3 shows the extended position of a human hand, cradled at the Z-shaped portion, which helps to prevent slippage.

### DETAILED DESCRIPTION OF THE PREFERRED EMBODIMENT

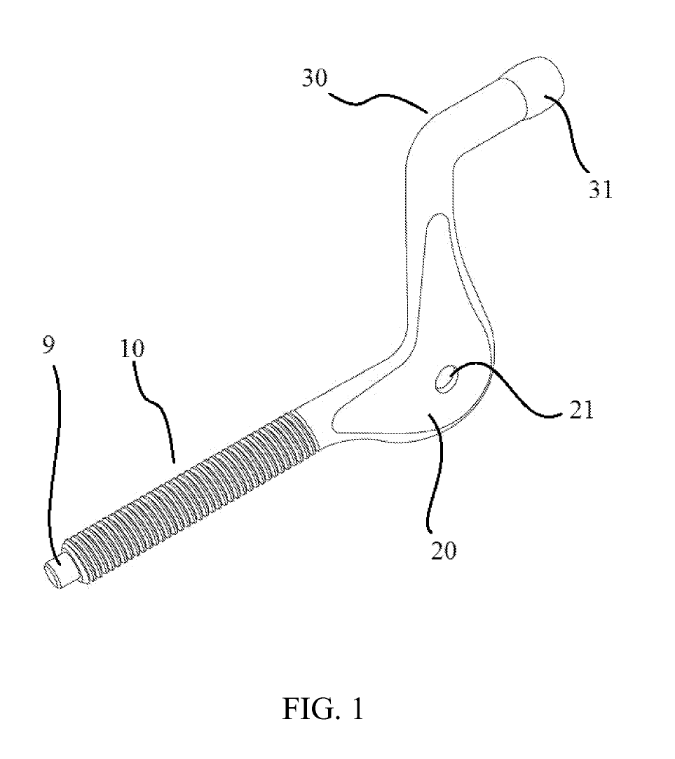

As shown in FIG. 1, the crank handle is a one-piece construction made up of three portions: threaded portion 10, Z-shaped portion 20, and an end portion 30.

The threaded portion 10 is generally in the shape of a straight cylinder with outside threads; it further contains a connecting tip 9 of a slightly reduced diameter at the distal end.

The Z-shaped portion 20 has a generally flat area forming a bent angle. A hole 21 is made to the generally central area of the flat area. Additional holes can be made to the flat area.

The end portion 30 is generally in the shape of a straight cylinder, with an optional end wrapping 31 at the distal end.

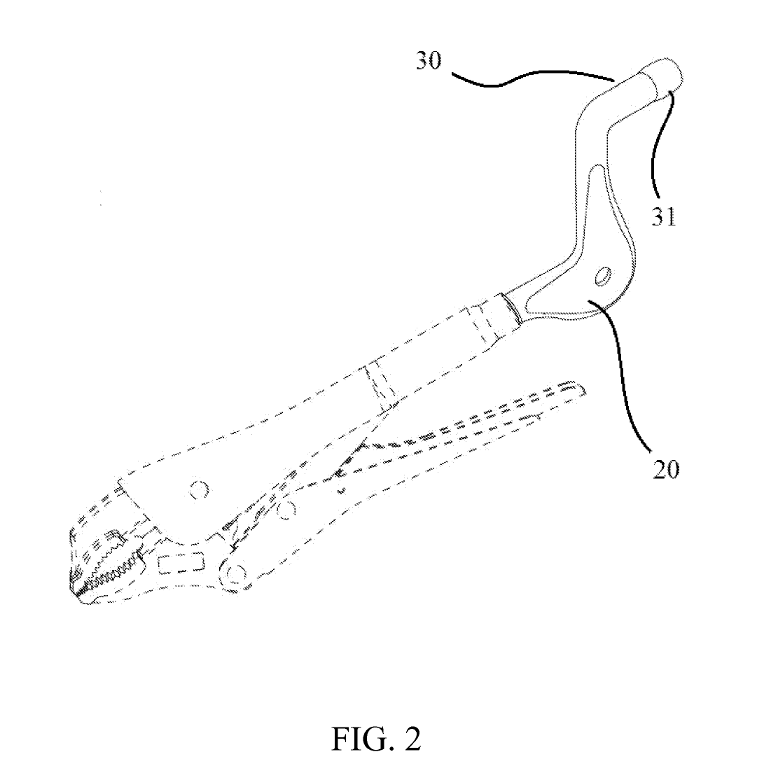

Additionally, the axial lines of threaded portion 10 and the end portion 30 can be made to be parallel to each other in a 3-D relationship. The connecting tip 9 serves to guide the crank handle into another piece of hardware tool, as illustrated in FIG. 2. The hardware tool is shown in dotted lines, indicating it is not part of the invention, nor is it claimed.

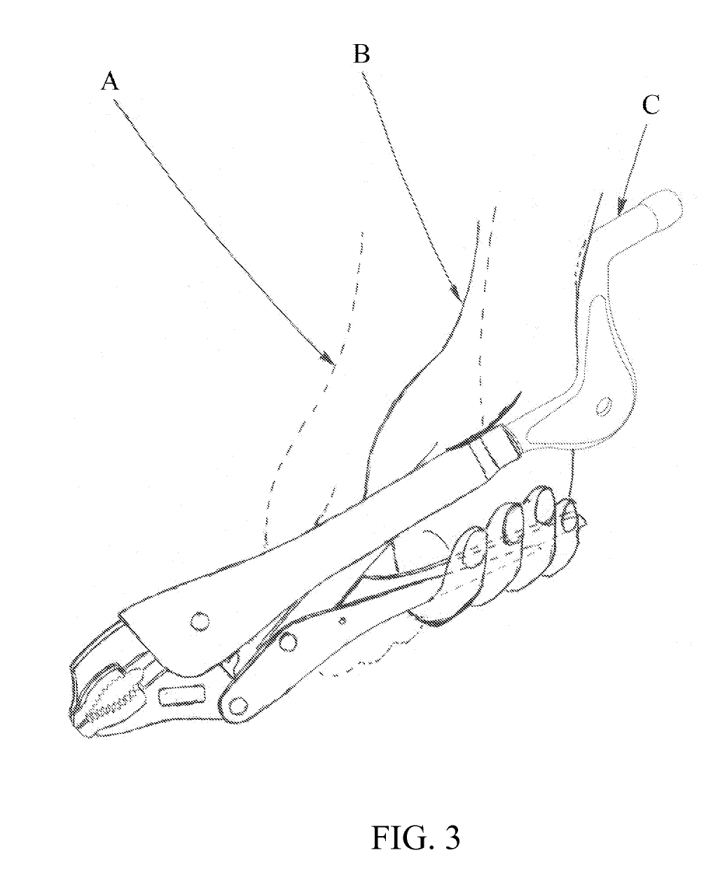

FIG. 3 shows the increased leverage on account of the crank handle herein.

Point A is the regular grip position for the hardware tool.

Point B is the extended grip position, with increased leverage.

Point C shows the impedance to slippage provided by the bent angle of the Z-shaped portion.

The human hand is cradled at the bent flat area of the Z-shaped portion 20, as shown by points B and C.

What is claimed is:

1. A one-piece crank handle, comprising,
a threaded portion generally in the shape of a straight cylinder;
a Z-shaped portion having a generally flat area forming a bent angle with a hole made to the central area of said flat area; and
an end portion generally in the shape of a straight cylinder.

2. The crank handle of claim 1, wherein the axial lines of said threaded portion and said end portion are generally parallel to each other in a 3-D relationship.

3. The crank handle of claim 1, wherein the end portion further having an end wrapping at a distal end.

4. The crank handle of claim 1, wherein additional holes can be made to the flat area of the Z-shaped portion.

5. The crank handle of claim 1, wherein the threaded portion further has a connecting tip of slightly reduced diameter.
